(19) United States
(12) Patent Application Publication
(10) Pub. No.: US 2019/0091929 A1
(43) Pub. Date: Mar. 28, 2019

(54) Reconfigurable Nozzle for Material Deposition

(71) Applicant: The Boeing Company, Chicago, IL (US)

(72) Inventors: Samuel Harrison, Lynnwood, WA (US); Nick S. Evans, Lynnwood, WA (US); Faraon Torres, Everett, WA (US); Michael P. Kozar, Mercer Island, WA (US); Mark S. Wilenski, Mercer Island, WA (US)

(73) Assignee: The Boeing Company, Chicago, IL (US)

(21) Appl. No.: 15/717,349

(22) Filed: Sep. 27, 2017

(51) Int. Cl. B29C 64/227; B29C 47/08; B29C 47/12; B33Y 30/00; B33Y 50/02; B29C 64/209; B29C 64/393

(52) U.S. Cl. CPC B29C 64/227; B29C 47/0801; B29C 47/12; B29C 64/393; B33Y 50/02; B29C 64/209; B33Y 30/00

(57) ABSTRACT

An extruder for depositing a material includes an extruder body including an extruder drive system and defining a body axis, and an extruder nozzle. The extruder nozzle includes a nozzle tip defining an exit orifice, a reconfigurable arm defining a material path in fluid communication with the exit orifice, the reconfigurable arm including a proximal end coupled to the extruder body and coaxial with the body axis, and a distal end coupled to the nozzle tip, and a plurality of actuators operatively associated with the reconfigurable arm and configured to move the reconfigurable arm between an initial configuration, in which the distal end of the reconfigurable arm is coaxial with the body axis, to a displaced configuration. In the displaced configuration, the distal end of the reconfigurable arm is at least one of positioned offset from the body axis and oriented at an angle relative to the body axis.

### TECHNICAL FIELD

The present disclosure relates generally to systems and apparatus used in material deposition and, more particularly, to nozzles used in such systems and methods.

### BACKGROUND

Deposition systems and apparatus are used in a variety of industries for precisely depositing materials. For example, extruders may use an extrusion nozzle to direct materials onto a surface to, for example, deposit industrial materials (e.g., sealants), additively manufacture a part (alternatively referred to as three-dimensional (3-D) printing), or for other purposes. Conventional extrusion systems typically control the extrusion nozzle in two axes of motion. For example, in conventional additive manufacturing processes that utilize extrusion apparatus for material deposition, during one iteration or layer of an additive manufacturing plan, the extrusion nozzle moves and is positioned about two axes, or, in other words, moves and is positioned substantially within or relative to a single, two-dimensional plane. Using such nozzles, movement about a third axis (e.g., raising and lowering the extrusion nozzle) is not performed until an iteration or layer of the additive manufacturing plan is complete. The constricted mobility and positioning of conventional extrusion nozzles make them inefficient for certain applications, and renders them entirely incapable of performing other types of processes.

### SUMMARY

In accordance with one example, an extruder is provided for depositing a material, the extruder including an extruder body including an extruder drive system and defining a body axis, and an extruder nozzle. The extruder nozzle includes a nozzle tip defining an exit orifice, a reconfigurable arm defining a material path in fluid communication with the exit orifice, the reconfigurable arm including a proximal end coupled to the extruder body and coaxial with the body axis, and a distal end coupled to the nozzle tip, and a plurality of actuators operatively associated with the reconfigurable arm and configured to move the reconfigurable arm between an initial configuration, in which the distal end of the reconfigurable arm is coaxial with the body axis, to a displaced configuration. In the displaced configuration, the distal end of the reconfigurable arm is at least one of positioned offset from the body axis and oriented at an angle relative to the body axis.

In accordance with an additional example, a system for material deposition includes an extruder having an extruder body and an extruder nozzle. The extruder body includes an extruder drive system and defines a body axis. The extruder nozzle includes a nozzle tip defining an exit orifice, a reconfigurable arm defining a material path in fluid communication with the exit orifice, the reconfigurable arm including a proximal end coupled to the extruder body and coaxial with the body axis, and a distal end coupled to the nozzle tip, and a plurality of actuators operatively associated with the reconfigurable arm and configured to move the reconfigurable arm between an initial configuration, in which the distal end of the reconfigurable arm is coaxial with the body axis, to a displaced configuration. In the displaced configuration, the distal end of the reconfigurable arm is at least one of positioned offset from the body axis and oriented at an angle relative to the body axis. A controller is operatively coupled to the extruder drive system and the plurality of actuators, and is programmed to operate at least one of the extruder drive system and the plurality of actuators based on material deposition instructions.

In accordance with a further example, an extruder is provided for depositing a material, the extruder including an extruder body having an extruder drive system and defining a body axis. An extruder nozzle includes a nozzle tip defining an exit orifice, and a reconfigurable arm defining a material path in fluid communication with the exit orifice. The reconfigurable arm includes a proximal end coupled to the extruder body and coaxial with the body axis, a distal end coupled to the nozzle tip, and a plurality of arm segments, each arm segment pivotably coupled to at least one other arm segment to permit rotation in an associated discrete rotational arc. A plurality of actuators is operatively associated with the reconfigurable arm and configured to move the reconfigurable arm between an initial configuration, in which the distal end of the reconfigurable arm is coaxial with the body axis, to a displaced configuration. In the displaced configuration, the distal end of the reconfigurable arm is at least one of positioned offset from the body axis and oriented at an angle relative to the body axis.

### BRIEF DESCRIPTION OF THE DRAWINGS

FIG. 1 is a side elevation view of an exemplary extruder for material deposition, in accordance with an embodiment of the present disclosure.

FIG. 2 is a plan view of the exemplary extruder of FIG. 1.

FIG. 3 is an additional side elevation view of the extruder of FIG. 1, illustrating an exemplary range of motion for an extruder tip of the extruder.

FIG. 4 is an additional plan view of the extruder of FIG. 1, further illustrating the exemplary range of motion for the extruder tip.

FIG. 5 is a schematic depiction of a system for material deposition utilizing an extruder, such as, for example, the extruder of FIG. 1.

FIG. 6 is a side elevation view of exemplary layer-wise iterations of an object to be manufactured via additive manufacturing and in accordance with a layer-wise additive manufacturing plan, in accordance with prior art systems, methods, and/or apparatus for material extrusion.

FIG. 7 is a side elevation view of exemplary layer-wise iterations of an object to be manufactured via additive manufacturing and in accordance with a layer-wise additive manufacturing plan, capable of being manufactured in such layers by utilizing the system of FIG. 5.

FIG. 8 is a side elevation view of an additional embodiment of exemplary layer-wise iterations of an object to be manufactured via additive manufacturing and in accordance with a layer-wise additive manufacturing plan, capable of being manufactured in such layers by utilizing the system of FIG. 5.

FIG. 9 is a side elevation view of yet another embodiment of exemplary layer-wise iterations of an object, to be manufactured via additive manufacturing and in accordance with a layer-wise additive manufacturing plan, capable of being manufactured in such layers by utilizing the system of FIG. 5.

FIG. 10 is a side elevation view of a further embodiment of exemplary layer-wise iterations of an object, to be manufactured via additive manufacturing and in accordance with a layer-wise additive manufacturing plan, capable of being manufactured in such layers by utilizing the system of FIG. 5.

FIG. 11 is a side elevation view of an exemplary robotic extrusion nozzle for material deposition in an initial configuration, in accordance with an embodiment of the present disclosure.

FIG. 12 is a side elevation view of the robotic extrusion nozzle of FIG. 11, with the robotic extrusion nozzle in an articulated configuration.

FIG. 13 is a plan view of the robotic extrusion nozzle of FIG. 11, with the robotic extrusion nozzle in the initial configuration.

FIG. 14 is a plan view of the robotic extrusion nozzle of FIG. 11, with the robotic extrusion nozzle in an articulated configuration.

FIG. 15 is a side elevation view of the extrusion nozzle of FIG. 11 illustrating an exemplary range of motion for an extruder tip of the extrusion nozzle.

FIG. 16 is a plan view of the exemplary extrusion nozzle of FIG. 11 illustrating the exemplary range of motion for the extruder tip, with the extruder tip in an articulated configuration.

FIG. 17 is a side elevation view of the extrusion nozzle of FIG. 11 illustrating the extrusion nozzle in an articulated configuration to access a tight-fit location.

FIG. 18 is a side elevation view of an alternative embodiment of the extrusion nozzle of FIG. 11, employing a mechanical actuator and a spring between arm segments.

FIG. 19 is a side elevation view of a further alternative embodiment of the extrusion nozzle of FIG. 11, employing two mechanical actuators between arm segments.

FIG. 20 is a side elevation view of yet another alternative embodiment of the extrusion nozzle of FIG. 11, employing expandable tube sections between arm segments, with the arm segments in an initial configuration.

FIG. 21 is a side elevation view of the extrusion nozzle of FIG. 20, with the arm segments in a displaced configuration.

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

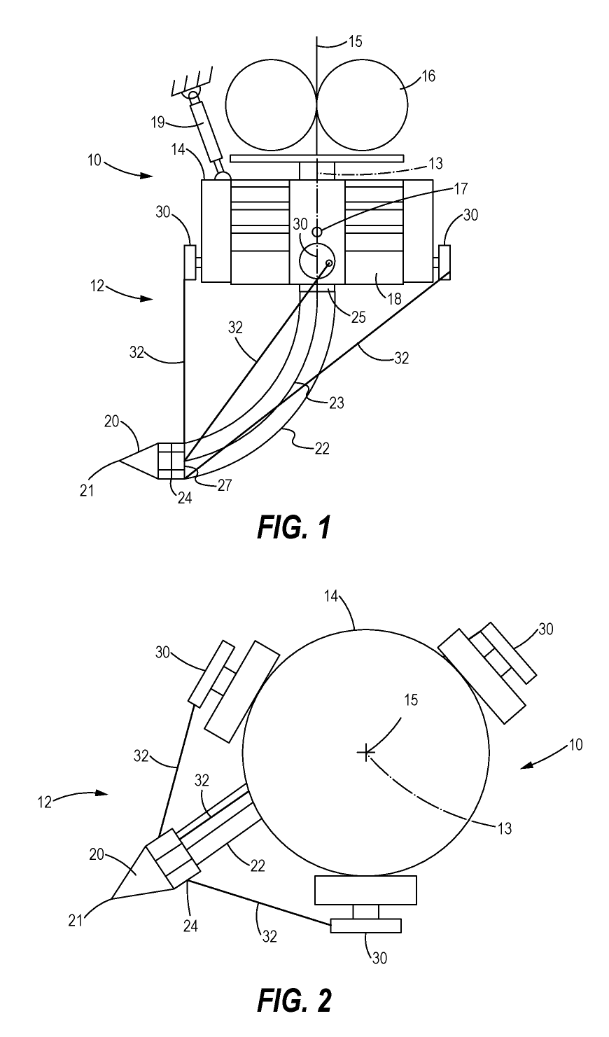

Turning now to the drawings and with specific reference to FIGS. 1 and 2, an extruder 10 for material deposition is shown. As defined herein, “material deposition” may refer to any laying or extrusion of any materials, via an extruder or like machinery. To that end, the extruder 10 may be used to deposit a variety of materials and/or for a variety of material deposition tasks, such as, but not limited to, deposition of industrial materials (e.g., sealants), construction, and additive manufacturing (alternatively referenced as three-dimensional (3-D) printing), among other purposes.

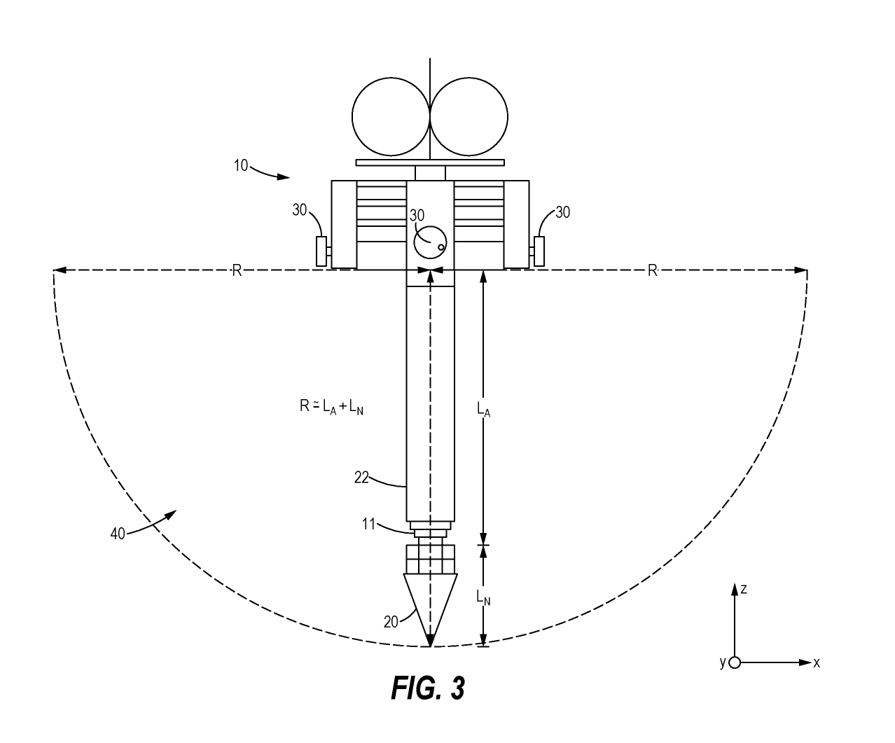

The extruder 10 generally includes an extruder nozzle 12 coupled to an extruder body 14 defining a body axis 13. The extruder nozzle 12 is capable of being manipulated to a desired position and angular orientation, as described in greater detail below. For example, the extruder nozzle 12 may be moved between an initial configuration and a displaced configuration. In the initial configuration, the extruder nozzle 12 extends substantially vertically, as shown in FIG. 3. When moved to the displaced configuration, the extruder nozzle is offset from the initial configuration so that a nozzle tip 20 has either an offset position or an offset angle, as shown in FIG. 1. FIG. 1 illustrates just one displaced configuration of several possible displaced configurations of the reconfigurable arm 22. For example, in the displaced configuration the nozzle tip 20 may have any one of several different positions, angle orientations, or combinations thereof.

Referring to FIGS. 1 and 2, the extruder body 14 includes an extruder drive system 16. The extruder drive system 16 may be any prime mover or other device configured to feed deposition material 15 through the extruder 10. In some embodiments, the extruder body 14 may further include a material processing zone 18 configured to project energy onto the deposition material 15 as it advances through the extruder body 14. The type of energy provided by the material processing zone 18 may be selected to convert the deposition material 15 from an initial state to a pre-processed state more suitable for deposition from the nozzle tip 20. For example, the material processing zone 18 may be a heat source which at least partially melts the deposition material from a solid and/or powdered state into a more viscous liquid, or semi-liquid, state. Such a heat source may be used, for example, in an additive manufacturing process known as fused deposition modeling. Alternatively, the material processing zone 18 may deliver other types of energy, such as ultra-violet (UV) light, which may be used in a photopolymer composite additive manufacturing process. Still further, the material processing zone 18 may deliver other types of energy suitable for the particular type of manufacturing process being used.

The extruder nozzle 12 is attached to or otherwise operatively associated with the extruder body 14. The extruder nozzle 12 includes a nozzle tip 20 having an exit orifice 21 through which deposition material 15 is deposited at the work site. A reconfigurable arm 22 defines a material path 23 that fluidly communicates with the exit orifice 21 through which the deposition material 15 passes as it travels to the nozzle tip 20. The reconfigurable arm 22 includes a proximal end 25 coupled to the extruder body 14 and coaxial with the body axis 13, and a distal end 27 coupled to the nozzle tip 20. The reconfigurable arm 22 is movable between an initial configuration, in which the distal end 27 of the reconfigurable arm 22 is coaxial with the body axis 13 as shown in FIG. 3, and a displaced configuration, as shown in FIG. 1. In the displaced configuration, the distal end 27 of the reconfigurable arm 22 is positioned offset from the body axis 13, oriented at an angle relative to the body axis 13, or both. The nozzle tip 20 is coupled to the distal end 27 of the reconfigurable arm 22, and therefore the nozzle tip 20 also assumes the position and angular orientation of the distal end 27, thereby permitting deposition of material 15 in a desired direction and location.

In the embodiment illustrated in FIGS. 1-4, the reconfigurable arm 22 is provided as flexible tubing configured for flexion. The reconfigurable arm 22 may be comprised of any suitable material for the material deposition task desired. Accordingly, the reconfigurable arm 22 may be configured from and or designed with materials having tolerances for specific environmental characteristics, such as tolerances for deposition material pressure and/or temperature tolerances associated with said materials. To that end, in some additive manufacturing contexts, it may be desirable for the flexible tubing to be formed of materials capable of withstanding heat temperatures of at least 100 degrees Celsius, and in some materials capable of withstanding heat temperatures of at least 300 degrees Celsius. Additionally, the material may be selected to withstand internal pressures of at least 5 psi, and in other embodiments at least 10 psi, at least 20 psi, at least 40 psi, or at least 65 psi.

In some embodiments, the extruder nozzle 12 optionally includes an auxiliary processing zone 24 mounted within and/or proximate to the nozzle tip 20. The auxiliary processing zone 24 provides a secondary source of energy to the deposition material 15 as it advances through the nozzle tip 20, thereby to maintain the deposition material 15 in a state suitable for deposition at the worksite. As with the material processing zone 18, the auxiliary processing zone 24 may be a heat source, a source of UV light, or other form of energy, depending on the type of manufacturing process employed.

The extruder 10 further includes a plurality of actuators 30 for moving the extruder nozzle 12 between the initial and displaced configurations. In the embodiment illustrated in FIGS. 1-4, the actuators 30 are configured to directly control a position and angular orientation of the nozzle tip 20, with the reconfigurable arm 22 permitting such movement while supporting the nozzle tip 20. As shown in FIGS. 1-4, the actuators 30 are servo actuators connected to the nozzle tip 20 via a plurality of servo linkages 32. In such examples wherein the plurality of actuators 30 include, at least, a plurality of servo actuators, the plurality of actuators 30 include at least three servo actuators, wherein each servo actuator is operatively associated with both the nozzle tip 20 and the extruder body 14.

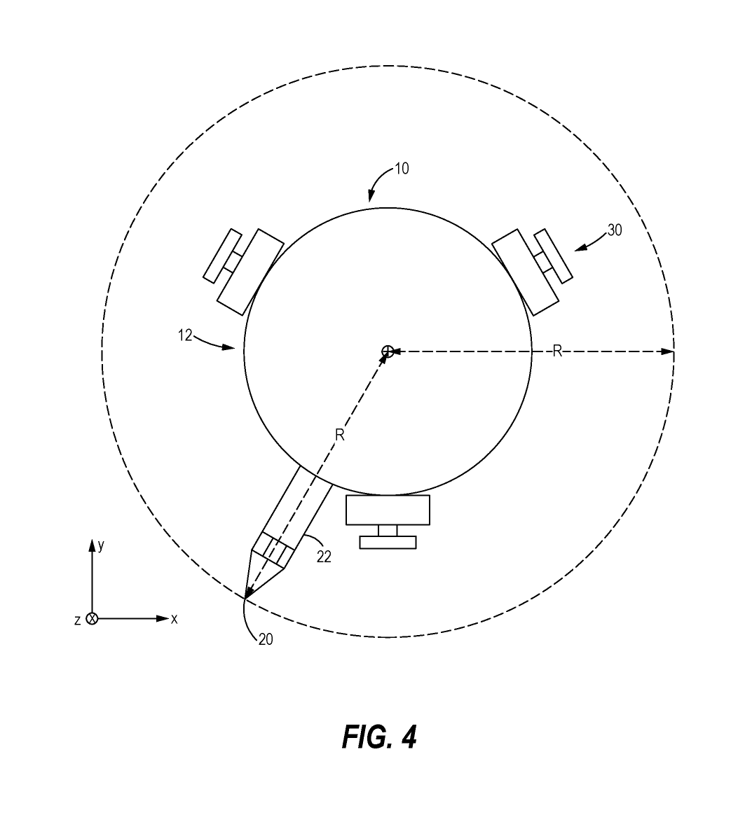

As best depicted in FIGS. 3 and 4, the plurality of actuators 30 are configured to position the nozzle tip 20 within a tip range of motion 40. The tip range of motion may be a 3-D range of motion within an X-Y-Z coordinate system. FIG. 3 illustrates the tip range of motion 40 within a X-Z plane, whereas FIG. 4 illustrates the tip range of motion 40 within a X-Y plane. The tip range of motion 40 may be defined and/or constrained, at least in part, by an effective arm length (L_{A}) of the reconfigurable arm 22. It should be noted that the effective arm length L_{A} may change depending on the position and orientation of the distal end 27 of the reconfigurable arm 22, particularly when nearing angle orientations of 180 degrees. The tip range of motion 40 further may be defined by an effective radius (R), wherein the effective radius R is defined as approximately the sum of the effective arm length L_{A} and a length of the nozzle tip 20 (L_{N}). Further, when based, at least in part, on the effective radius R, the tip range of motion 40 may be defined, at least in part, by a partial near-spheroid having the effective radius R.

Additionally, in some embodiments, the extruder nozzle 12 as an adjustable effective arm length L_{A} to expand the tip range of motion 40. For example, as best shown in FIG. 3, the extruder nozzle 12 may include an adjustable length segment, such as telescoping segment 11, that allows the length of the extruder nozzle 12 to be changed. While the telescoping segment 11 is shown as being located near the distal end 27 of the reconfigurable arm 22, it will be appreciated that the telescoping segment 11 may be provided anywhere along the length of the reconfigurable arm 22. The telescoping segment 11 may be expanded using the plurality of actuators 30, or additional actuators may be provided specifically for adjusting a length of the telescoping segment 11. By providing the ability of the extruder nozzle 12 to changes its effective arm length L_{A}, the adjustable length segment expands the range of motion 40 of the extruder nozzle 12, thereby increasing the types of builds that may be formed using the extruder 10.

Still further, the tip range of motion 40 may be further expanded by optionally providing a pivotable extruder body 14. As best shown in FIG. 1, the extruder body 14 may be mounted for rotation about a pivot point 17, which may permit rotation of the extruder body 14 about three orthogonal axes. At least one pivot actuators 19 is coupled to the extruder body 14 and operable to pivot the extruder body 14 about the pivot point 17. By providing a pivotable extruder body 14, the tip range of motion 40 may be expanded, thereby increasing the types of builds that may be formed using the extruder 10.

By enabling the tip range of motion 40, the extruder 10 may be capable of having much greater ranges of motion, when compared to prior art extruders. For example, many prior art extruders are merely capable of two dimensional movement during a given material deposition iteration. However, by using the plurality of actuators 30 to enable the tip range of motion 40, the nozzle tip 20 can be positioned for material deposition with three-dimensional layer-wise iterations.

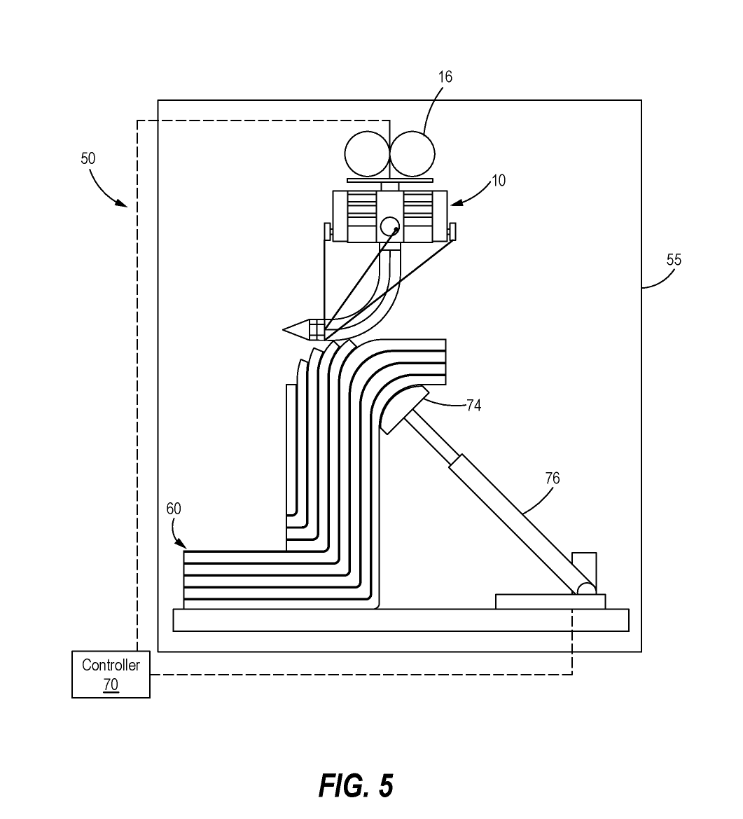

To that end, FIG. 5 illustrates a system 50 for material deposition, which utilizes, at least, the extruder 10 to execute a material deposition process within a workspace 55. For example and as depicted, the system 50 may be utilized to execute an additive manufacturing plan 60, which includes, at least, material deposition instructions. The system 50 also includes the extruder drive system 16. Accordingly, the system 50 further includes a controller 70, which is configured to provide instructions to the plurality of actuators 30 and the extruder drive system 16 based at least in part on material deposition instructions. Such material deposition instructions are, for example, a part of an additive manufacturing plan 60.

While FIG. 5 (and the related FIGS. 7-10) depict additive manufacturing plans, it is to be noted that the system 50 is not limited to use for executing additive manufacturing plans and may be used in any computer-controlled material deposition scenarios. Accordingly, in such examples, the controller 70 is configured to operate the actuators 30 and extruder drive system 16 based on the additive manufacturing plan 60. Further, in some such examples, melting of the materials for deposition at the material processing zone 18 and feeding of the molten materials from the material processing zone 18 to the nozzle tip 20 is controlled based on the instructions, of the additive manufacturing plan 60, from the controller 70. In some examples, the system 50 includes a support platen 74, which is configured to provide under-side support to a mid-build object, wherein the mid-build object is being additively manufactured by the extruder 10, in accordance with the additive manufacturing plan 60. In some such examples, the system 50 may further include a support 76, operatively associated with the support platen 74 and the controller 70, which is configured to control positioning of the support platen 74, during the additive manufacturing process of the additive manufacturing plan 60.

The controller 70 may be any electronic controller or computing system including a processor which operates to perform operations, execute control algorithms, store data, retrieve data, gather data, and/or any other computing or controlling task desired. The controller 70 may be a single controller or may include more than one controller disposed to control various functions of the extruder 10 and/or any other elements of or associated with the system 50. Functionality of the controller 70 may be implemented in hardware and/or software and may rely on one or more data maps relating to the operation of the system 50. To that end, the controller 70 includes memory, which may include internal memory, and/or the controller 70 may be otherwise connected to external memory, such as a database or server. The internal memory and/or external memory may include, but are not limited to including, one or more of read only memory (ROM), random access memory (RAM), a portable memory, and the like. Such memory media are examples of nontransitory memory media.

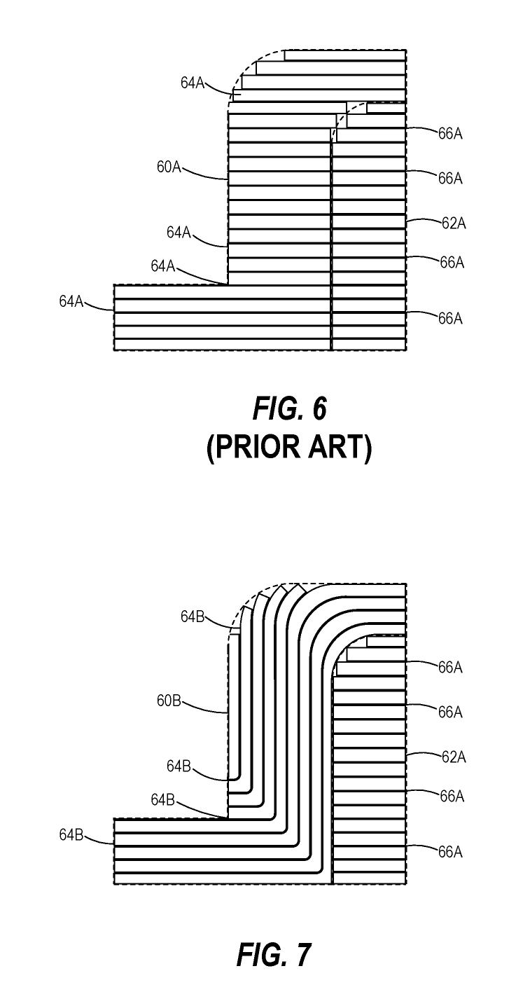

Turning now to FIGS. 6-10, a plurality of versions of implementation of the additive manufacturing plan 60 are depicted. First, FIG. 6 illustrates a first implementation for the additive manufacturing plan 60A, which, while the system 50 would be capable of executing the additive manufacturing plan 60A, it also would be feasible using prior art systems and methods. The additive manufacturing plan 60A includes plans for object layers 64A, for manufacturing the build object, and support manufacturing plans 62A, which include support layers 66A for building a support structure for the object. As depicted, both the object layers 64A and the support layers 66A extend laterally, therefore an extruder would only need to be able to position within a lateral and/or longitudinal space.

Alternatively, as depicted in FIGS. 7-10, using the system 50, rather than prior art systems or apparatus, the extruder 10 can deposit material in layers that can extend about or within the lateral space, the longitudinal space, and, particularly the vertical space. This may enable quicker material deposition plans, having fewer layers. Further, such three-dimensional movement spaces may enable material deposition spaces within work spaces that prior art systems and methods may not be able to access, due to the flexion provided by the extruder 10.

Beginning with FIG. 7, a second implementation of the additive manufacturing plan 60B is depicted, having plans for a series of object layers 64B. As shown, the object layers 64B can extend about both the lateral and vertical directions and, while not shown, also extend in the longitudinal direction. Such extension of the object layers 64B is enabled by the nozzle tip 20 having the ability to operate within the tip range of motion 40.

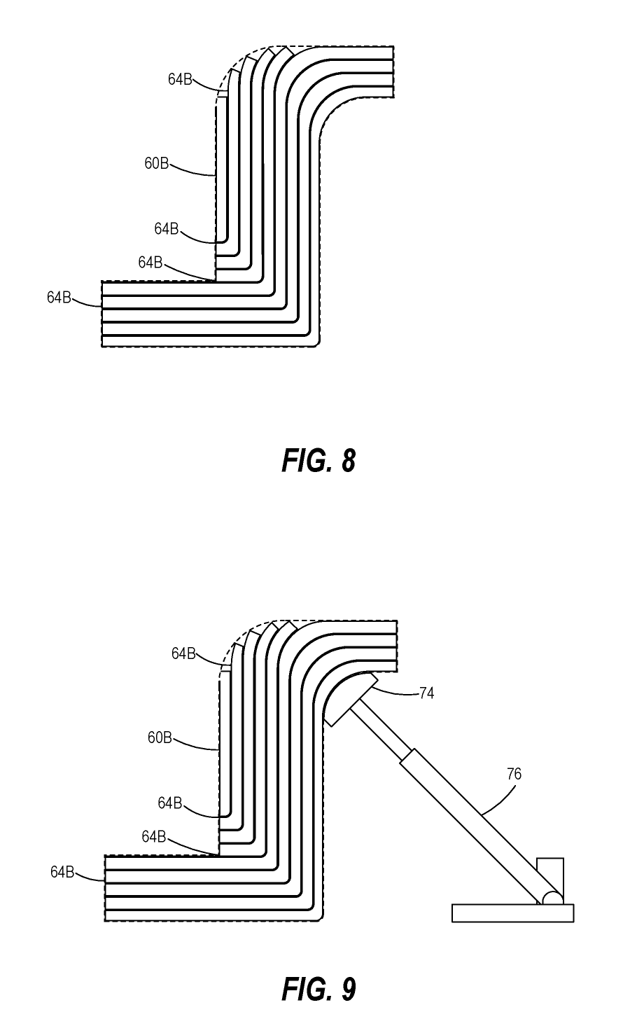

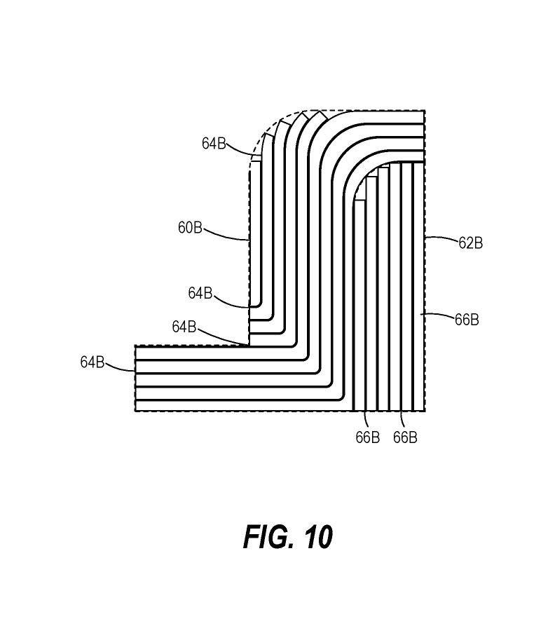

In the example of FIG. 7, support manufacturing plans 62A, similar to those of FIG. 6, may be used for similar support when constructing via the additive manufacturing plan 60B. Alternatively, in some examples, such as that of FIG. 8, the additive manufacturing plan 60B may be capable of execution without any support structure. In such example, additives or other stiffening agents may be present within the materials for deposition, allowing such manufacture to solidify without a support structure. In another alternative example illustrated in FIG. 9, the support platen 74 may be utilized, in the place of a support structure such as that generated by the support manufacturing plans 62A, may be utilized and positioned by the support 76, as support during build of an object in accordance with the additive manufacturing plan 60B. Lastly, as depicted in FIG. 10, an alternative support structure plan 62B may be utilized and manufactured by the extruder 10, wherein the alternative support structure plan 62B includes a plurality of vertically oriented support layers 66B. Such a plan 62B may be capable of manufacture due to the vertical motion abilities of the extruder 10.

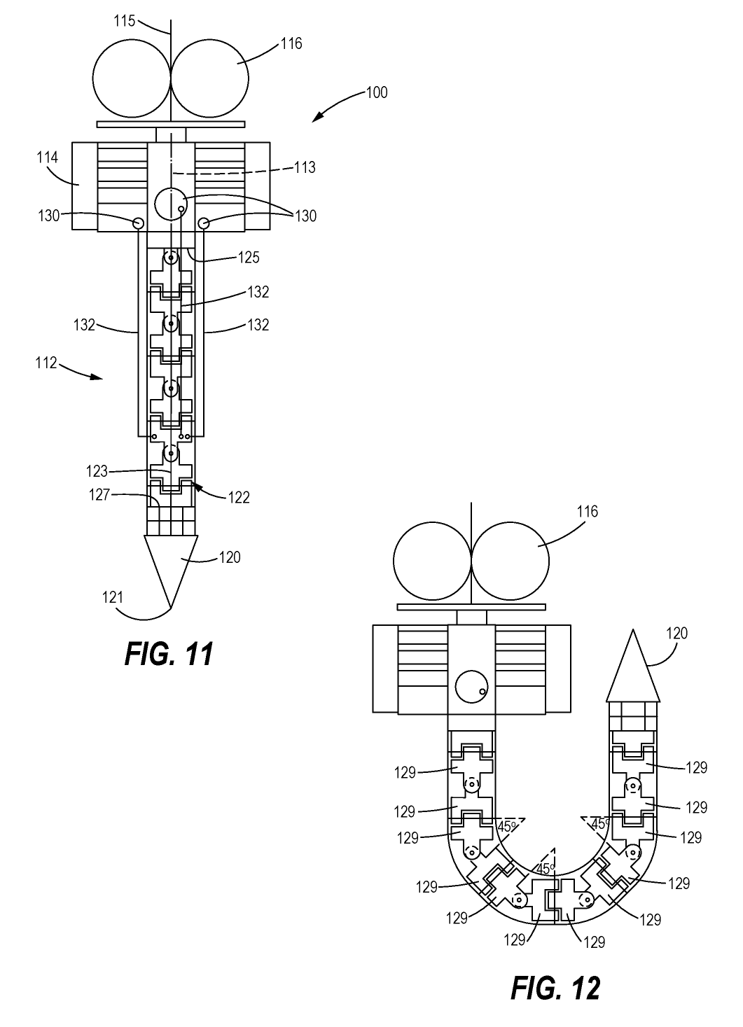

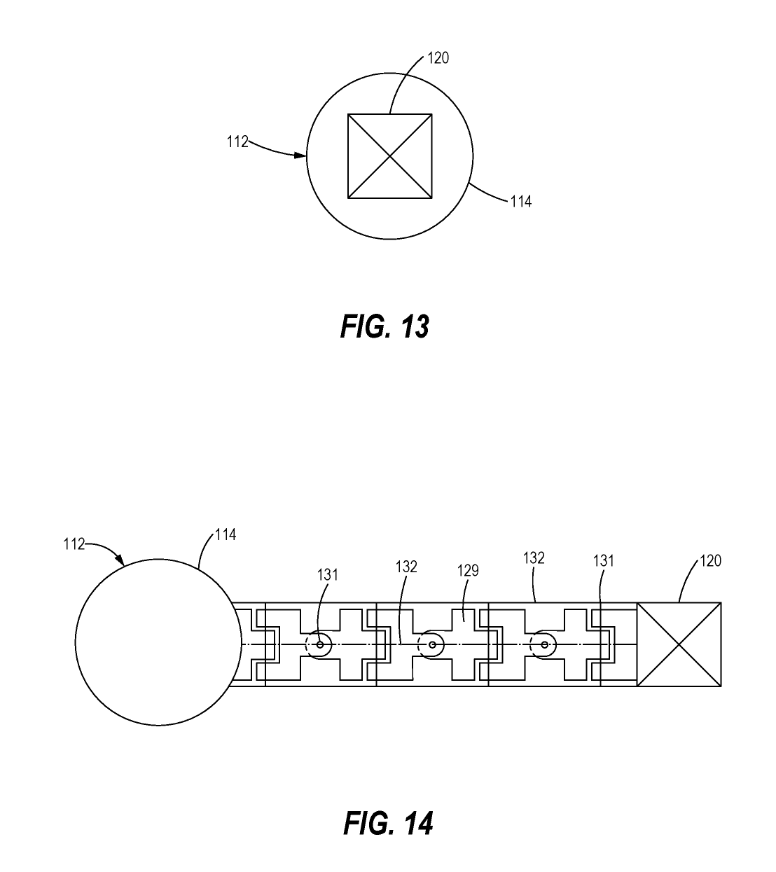

An alternative extruder 100 is illustrated in FIGS. 11-17. Similar to the extruder 10 shown in FIGS. 1-4, the extruder 12 includes an extruder nozzle 112 capable of moving between initial and displaced configurations, however the extruder nozzle 112 is of an articulated type, as described in greater detail below. The extruder 100 may be used with the above-noted controller 70 either on its own or within the system 50 described above.

The extruder 100 includes an extruder body 114 defining a body axis 113. The extruder body 114 includes an extruder drive system 116 configured to feed deposition material 115 through the extruder 100. The extruder nozzle 112 is coupled to the extruder body 114 and includes a nozzle tip 120 having an exit orifice 121 through which deposition material 115 is deposited at the work site. A reconfigurable arm 122 defines a material path 123 that fluidly communicates with the exit orifice 121 and through which the deposition material 115 passes as it travels to the nozzle tip 120. The reconfigurable arm 122 includes a proximal end 125 coupled to the extruder body 114 and coaxial with the body axis 113, and a distal end 127 coupled to the nozzle tip 120. The reconfigurable arm 122 is movable between an initial configuration, in which the distal end 127 of the reconfigurable arm 122 is coaxial with the body axis 113, as shown in FIG. 11, and a displaced configuration, as shown in FIG. 12. In the displaced configuration, the distal end 127 of the reconfigurable arm 122 is positioned offset from the body axis 113, oriented at an angle relative to the body axis 113, or both. FIG. 12 illustrates just one displaced configuration of several possible displaced configurations of the reconfigurable arm 122. For example, in the displaced configuration the distal end 127 may have any one of several different positions, angle orientations, or combinations thereof. The nozzle tip 120 is coupled to the distal end 127 of the reconfigurable arm 122, and therefore the nozzle tip 120 also assumes the position and angular orientation of the distal end 127, thereby permitting deposition of material 115 in a desired direction and location.

In the embodiment illustrated in FIGS. 11-17, the reconfigurable arm 122 has articulating segments which permit movement of the reconfigurable arm 122 to the displaced configuration. Accordingly, the extruder nozzle 112 includes a plurality of arm segments 129, with each arm segment 129 pivotably coupled to at least one other arm segment 129 to permit rotation in an associated, discrete rotational arc. In the illustrated embodiment, the arm segments 129 are directly pivotably coupled to each other, however in other embodiments intervening components may be provided between adjacent arm segments 129 so that they are indirectly pivotably coupled. Each arm segment 129 may pivot about a segment axis 131.

The arm segments 129 may be oriented so that the segment axes 131 of different arm segments 129 extend at different angles, thereby to permit the reconfigurable arm to be displaced in three orthogonal axes. For example, the arm segments 129 may be oriented so that the segment axes 131 alternate between orthogonal angles. That is, a first arm segment 129 may have a segment axis 131 extending longitudinally (into and out of the page as shown in FIG. 11), while a second, adjacent arm segment 129 may have a segment axis 131 extending laterally (across the page as shown in FIG. 11). The segment axes 131 may continue alternating for subsequent arm segments 129, so that a third arm segment 129 pivots about a longitudinal segment axis 131, a fourth arm segment 129 pivots about a lateral segment axis 131, and so on. In this way, the distal end 127 of the reconfigurable arm 122 is capable of displacement in three orthogonal axes relative to the proximal end 125.

While the illustrated embodiment is shown having eight arm segments 129 (FIG. 11) and twelve arm segments (FIG. 12), more or fewer arm segments 129 may be used having similar or different discrete rotational arcs. Further, while the discrete rotation arc for each of the arm segments 129 is shown as approximately 45 degrees, any suitable arc for positioning purposes may be used. In the example, the nozzle tip 120 may be capable of at least 180 degrees of rotation about one or more axes.

A plurality of actuators 130 is operatively associated with the reconfigurable arm 122 for moving the reconfigurable arm 122 between initial and displaced configurations. In the embodiment illustrated at FIG. 11, the actuators 130 are operatively coupled to at least one arm segment 129 using tension wires 132. The tension wires 132 may be positioned closely adjacent to exterior surfaces of the arm segments 129 as shown to reduce a cross-sectional profile of the extruder nozzle 112, thereby facilitating use in areas having limited space.

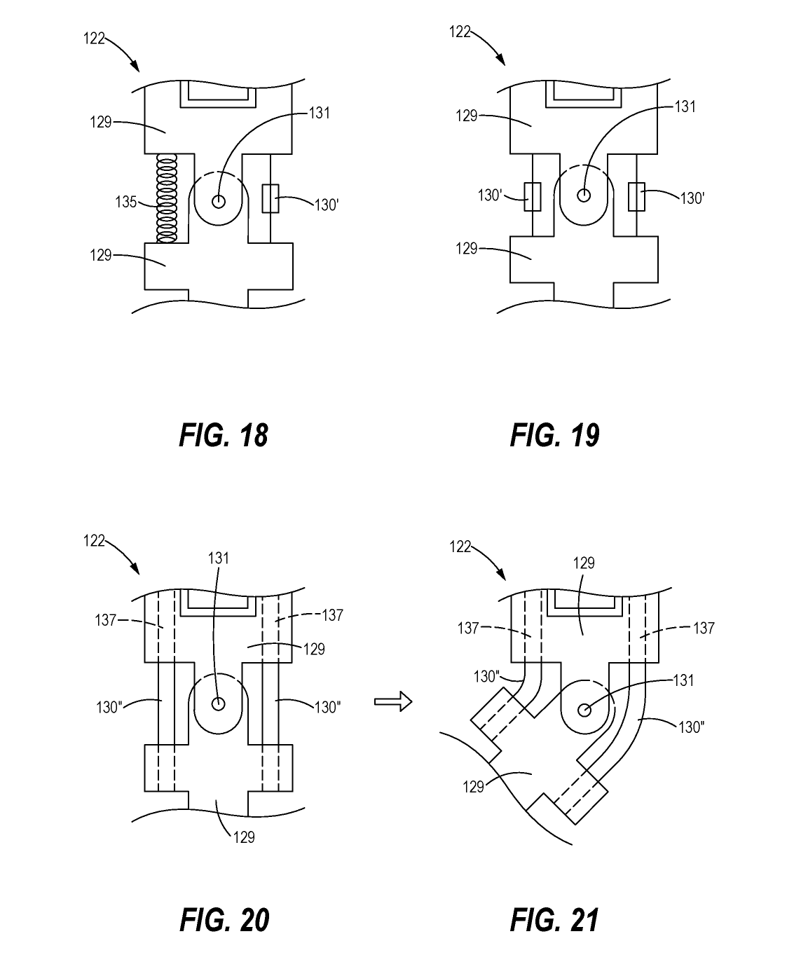

Alternatively, mechanical actuators 130′ may be provided between arm segments 129, as shown in FIGS. 18 and 19. In FIG. 18, a single mechanical actuator 130′ is provided on one side between adjacent arm segments 129, while a return spring 135 is provided on an opposite side of the arm segments 129. The return spring 135 may be configured to return the arm segment 129 to an initial configuration in the absence of displacement of the mechanical actuator 130′. In FIG. 19, at least two mechanical actuators 130′ are provided between adjacent arm segments 129, and the at least two mechanical actuators 130′ may be cooperatively controlled to move the reconfigurable arm 122 between initial and displaced configurations.

In yet another embodiment, expandable tube sections 130″ may be used as actuators between adjacent arm segments 129. As best shown in FIGS. 20 and 21, at least two elastomeric tubes 137 pass through the arm segments 129. Tube sections 130″ of the elastomeric tubes 137 are not constrained by surrounding components, and therefore are free to expand. Accordingly, when fluid pressure inside the elastomeric tubes 137 is increased, the tube sections 130″ may expand. Thus, increasing the pressure inside one of the elastomeric tubes 137 will expand the associated tube section 130″, thereby causing a relative pivoting movement between adjacent arm segments 129. Fluid pressure inside the elastomeric tubes 137 may be cooperatively controlled to move the reconfigurable arm 122 to the desired displaced configuration.

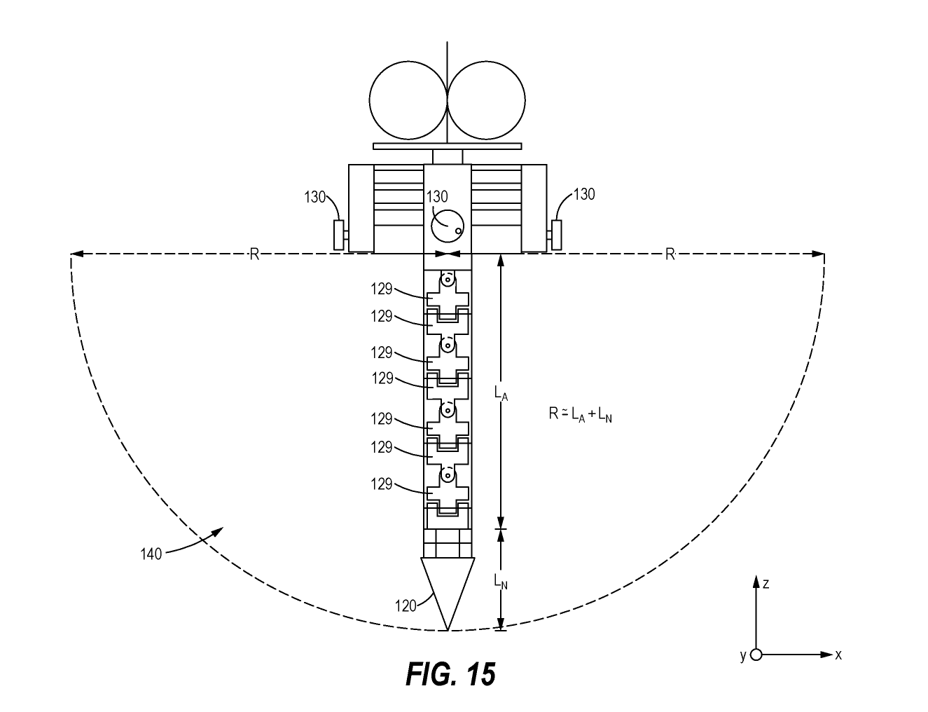

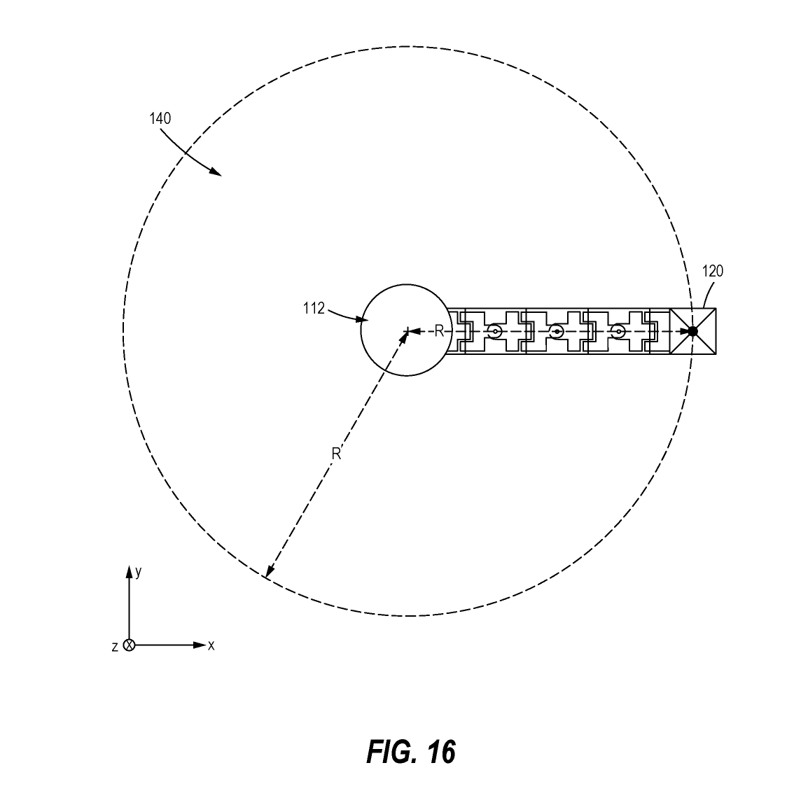

The reconfigurable arm 122 of the extruder nozzle 112 permits the nozzle tip 120 to be positioned within a tip range of motion 140, as best shown in FIGS. 15 and 16. The tip range of motion may be a 3-D range of motion within an X-Y-Z coordinate system. FIG. 15 illustrates the tip range of motion 40 within a X-Z plane, whereas FIG. 16 illustrates the tip range of motion 40 within a X-Y plane. The tip range of motion 140 may be defined and/or constrained, at least in part, by an effective arm length (L_{A}) of the reconfigurable arm 122. It should be noted that the effective arm length L_{A} may change depending on the position and orientation of the distal end 127 of the reconfigurable arm 122, particularly when nearing angle orientations of 180 degrees. The tip range of motion 140 further may be defined by an effective radius (R), wherein the effective radius R is defined as approximately the sum of the effective arm length L_{A} and a length of the nozzle tip 20 (L_{N}). Further, when based, at least in part, on the effective radius R, the tip range of motion 140 may be defined, at least in part, by a partial near-spheroid having the effective radius R.

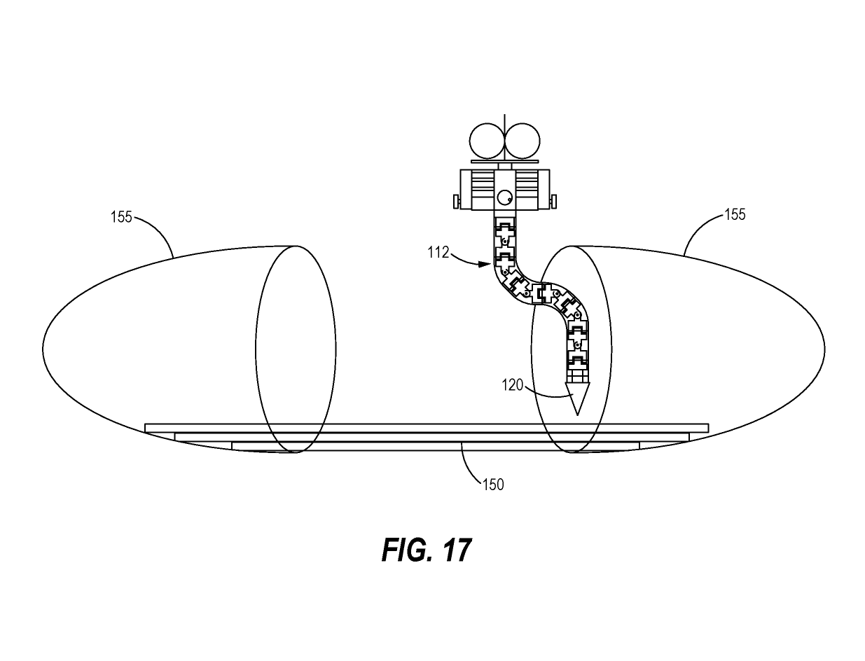

By enabling the tip range of motion 140, the extruder 100 may be capable of having much greater ranges of motion, when compared to prior art extruders. For example, many prior art extruders are merely capable of two dimensional movement during a given material deposition iteration. However, by using the plurality of actuators 130 to enable the tip range of motion 140, the nozzle tip 120 can be positioned for material deposition with three-dimensional layer-wise iterations. Furthermore, the plurality of arm segments 129, in combination with the tip range of motion 140, enables the nozzle tip 120 to be positioned for material deposition with difficult to reach spaces. For example, as depicted in FIG. 17, the nozzle 112 may be used to deposit material layers 150 within hard to reach spaces, such as within the tight quarters within pre-deposited shells 155.

What is claimed is:

1. An extruder for depositing a material, the extruder comprising:
an extruder body including an extruder drive system and defining a body axis;
an extruder nozzle including:
a nozzle tip defining an exit orifice;
a reconfigurable arm defining a material path in fluid communication with the exit orifice, the reconfigurable arm including a proximal end coupled to the extruder body and coaxial with the body axis, and a distal end coupled to the nozzle tip; and
a plurality of actuators operatively associated with the reconfigurable arm and configured to move the reconfigurable arm between an initial configuration, in which the distal end of the reconfigurable arm is coaxial with the body axis, to a displaced configuration, in which the distal end of the reconfigurable arm is at least one of:
positioned offset from the body axis; and
oriented at an angle relative to the body axis.

2. The extruder of claim 1, wherein the reconfigurable arm has an effective arm length L_{A}, and wherein the plurality of actuators is further configured to position the nozzle tip within a tip range of motion, the tip range of motion defined, at least in part, by the effective arm length L_{A}.

3. The extruder of claim 1, in which the reconfigurable arm comprises a flexible tubing, and the plurality of actuators include at least three servo actuators operatively associated with both the extruder body and the nozzle tip.

4. The extruder of claim 3, in which each of the at least three servo actuators includes a servo linkage connecting each of the at least three servo actuators to the nozzle tip.

5. The extruder of claim 3, wherein the flexible tubing is comprised of a material capable of withstanding at least 100 degrees Celsius and maintaining stability at internal pressures of at least 5 pounds per square inch.

6. The extruder of claim 1, in which the extruder body further includes a material processing zone configured to direct energy toward the material when located in the extruder body.

7. The extruder of claim 1, in which the extruder nozzle further includes an auxiliary processing zone mounted proximate to the nozzle tip.

8. The extruder of claim 1, in which the reconfigurable arm further includes a plurality of arm segments, each arm segment pivotably coupled to at least one other arm segment to permit rotation in an associated discrete rotational arc.

9. The extruder of claim 8, in which the associated discrete rotational arc is approximately 45 degrees.

10. A system for material deposition, the system comprising:
an extruder including:
an extruder body including an extruder drive system and defining a body axis;
an extruder nozzle including:
a nozzle tip defining an exit orifice;
a reconfigurable arm defining a material path in fluid communication with the exit orifice, the reconfigurable arm including a proximal end coupled to the extruder body and coaxial with the body axis, and a distal end coupled to the nozzle tip; and
a plurality of actuators operatively associated with the reconfigurable arm and configured to move the reconfigurable arm between an initial configuration, in which the distal end of the reconfigurable arm is coaxial with the body axis, to a displaced configuration, in which the distal end of the reconfigurable arm is at least one of:
positioned offset from the body axis; and
oriented at an angle relative to the body axis; and
a controller operatively coupled to the extruder drive system and the plurality of actuators, the controller being programmed to operate at least one of the extruder drive system and the plurality of actuators based on material deposition instructions.

11. The system of claim 10, in which the material deposition instructions comprise an additive manufacturing plan for building an object via additive manufacturing.

12. The system of claim 11, in which the extruder body further includes a material processing zone configured to direct energy toward the material when located in the extruder body, and in which the controller is further operatively associated with the material processing zone and is further programmed to operate the material processing zone based on the additive manufacturing plan.

13. The system of claim 11, further comprising a support platen, the support platen configured to provide under-side support to a mid-build object, the mid-build object being additively manufactured by the extruder, in accordance with the additive manufacturing plan.

14. An extruder for depositing a material, the extruder comprising:
an extruder body including an extruder drive system and defining a body axis; and
an extruder nozzle including:
a nozzle tip defining an exit orifice;
a reconfigurable arm defining a material path in fluid communication with the exit orifice, the reconfigurable arm including:
a proximal end coupled to the extruder body and coaxial with the body axis;
a distal end coupled to the nozzle tip; and
a plurality of arm segments, each arm segment pivotably coupled to at least one other arm segment to permit rotation in an associated discrete rotational arc; and
a plurality of actuators operatively associated with the reconfigurable arm and configured to move the reconfigurable arm between an initial configuration, in which the distal end of the reconfigurable arm is coaxial with the body axis, to a displaced configuration, in which the distal end of the reconfigurable arm is at least one of:
positioned offset from the body axis; and
oriented at an angle relative to the body axis.

15. The extruder of claim 14, in which the plurality of actuators is coupled to at least one of the plurality of arm segments by tension wires.

16. The extruder of claim 14, in which the extruder body is mounted for pivoting about a pivot point.

17. The extruder of claim 14, in which the reconfigurable arm further includes an adjustable length segment.

18. The extruder of claim 14, in which the plurality of actuators are disposed between adjacent arm segments.

19. The extruder of claim 18, in which the plurality of actuators comprises a plurality of mechanical actuators.

20. The extruder of claim 18, in which the plurality of actuators comprises expandable tube sections.
